(19) United States
(12) Patent Application Publication
(10) Pub. No.: US 2005/0276514 A1
(43) Pub. Date: Dec. 15, 2005

(54) Image monitoring method and system

(76) Inventor: Paul A. Fisher, Scottsdale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/868,438

(22) Filed: Jun. 14, 2004

(51) Int. Cl. G06K 9/64; G06K 9/36

(52) U.S. Cl. 382/286; 382/278

(57) ABSTRACT

A system for verifying the accuracy of an image generated by a display processor and rendering engine is disclosed. The system includes a correlator circuit. The correlator circuit is operable to capture image data produced by a rendering engine from a set of input data and determine a correlation value calculated using a comparison location within the image data and a template. The correlator is further operable to compare the correlation value against a threshold value to determine a match between the comparison location within the image data and the template. The system further includes a checking processor coupled to the correlator circuit. The checking processor is operable to receive data representative of the correlation from the correlator and is further operable to initiate a warning in the event of any error in the data representative of the correlation.

### TECHNICAL FIELD

This invention relates to the field of video processing and more particularly to an image monitoring method and system.

### BACKGROUND

An operator of a system often relies upon visual indicators to show, among other things, the state of the system. For example, the operator of an aircraft can be provided with, among other indicators, a visual indication of the horizon line and altitude of the aircraft. At one time these visual indicators were provided using analog, mechanical displays. Increasingly, electronic display panels, comprised of a number of individually addressable pixels, are being used to provide visual indication of system status. Typically, to display the symbology that provides visual indicators, a graphic processor is used to generate the symbology, which is displayed on a display. If the processor somehow fails and items are displayed incorrectly, serious consequences could result up to and including the loss of the aircraft.

Because of the importance of correctly displaying critical information, aircraft certification authorities (such as the Federal Aviation Administration) require that the data sent to the display be monitored. The monitoring system used to check the data going to the display typically must be independent of the primary display function. Certification authorities sometimes require that no single failure cause a particular failure. Even if that is not required for a particular failure, calculating the probability of the failure as the product of the failure of the primary display function and the monitor requires that those two events be independent. If the failures are not independent, failures that corrupt both the display function and the monitor must be identified, and the probability of the common failures will tend to dominate the failure probability.

In a typical prior art system, the display system includes a display processor that receives information regarding the images to be displayed from other airborne systems and sensors and generates commands to produce the images. The commands are received by a rendering engine, which uses the commands to generate the image to be displayed by determining the state of each pixel in the display based on the generated commands. The display receives the information regarding each pixel and sets each pixel in the display that comprises the image to the proper state.

In prior art systems, the data produced by the display processor and the data produced by the rendering engine are checked as two separate operations. The display commands produced by the display processor from input data are received by a comparator circuit (or processor). The comparator circuit also receives the same input that the display processor used to generate the display commands. Since it is still relatively easy to extract the input data from the display commands, the comparator circuit compares the data from the display processor with data that the comparator circuit calculated from the input. If there is a match, this part of the verification passes and the display processor is producing the correct commands from a given input.

The display processor also inserts a sequence of test commands in the commands sent to the rendering engine. These commands rendered test images in the extended areas of the display that are not visible to the user. The extended areas of the display output of the rendering engine are sampled and a cyclic redundancy check (CRC) value is calculated from the sample data. The CRC value is then compared to an expected CRC value to determine if there is a failure in the rendering engine. For this monitoring scheme to be valid, the rendering engine must be simple enough that there is no failure, not detected by the CRC test patterns, which will produce a coherent but incorrect display. In other words, all failures of the rendering engine that do not fail the CRC test must lead to a display that is obviously incorrect.

While the prior art system were adequate for monitoring many display systems, an increasing reliance on commercial off the shelf (COTS) display chips has made the task of monitoring the display system more difficult and problematic. One reason is because the architecture of display systems, especially those based on commercial off the shelf display chips, have undergone changes that render previous monitoring systems inadequate. For example, some COTS rendering engines include integrated circuits that may incorporate finctions previously performed in the display processor. This change makes previous methods of monitoring display systems unusable; it is impossible to extract the commands that generate the pixel values from inside the COTS display chip. Additionally, manufacturers of integrated circuits for rendering engines are reluctant to disclose the internal architecture of the rendering engines due to competitive concerns. In such cases, establishing the adequacy of the CRC test of the rendering engine is difficult or impossible. What is needed is an improved image monitoring method and system that operates only on the output of the rendering engine.

### SUMMARY

In one embodiment of the present invention, a method for verifying the accuracy of image data generated by a display processor from an initial set of input parameters is disclosed. The method includes capturing image data at a correlator, receiving at least one comparison location including a first symbology within the image data and receiving a template representing a second symbology. Next, the method includes the step of calculating a correlation value using the comparison location and the template and comparing the correlation value to a threshold value. If the correlation value exceeds the threshold value a match between the first symbology appearing in the comparison location and the symbology represented by template is made.

In another embodiment, a system for verifying the accuracy of an image generated by a display processor and rendering engine is disclosed. The system includes a correlator circuit. The correlator circuit is operable to capture image data produced by a rendering engine from a set of input data and determine a correlation value calculated using a comparison location within the image data and a template. The correlator is further operable to compare the correlation value against a threshold value to determine a match between the comparison location within the image data and the template. The system further includes a checking processor coupled to the correlator circuit. The checking processor is operable to receive data representative of the correlation from the correlator and is further operable to initiate a warning in the event of any error in the data representative of the correlation.

### BRIEF DESCRIPTION OF THE DRAWINGS

The present invention will herein be described in conjunction with the following drawings and figures, wherein like numerals denote like elements and wherein:

FIG. 1 is a block diagram of an embodiment of a display verification system in accordance with the teachings of the present invention;

FIG. 2 is a block diagram illustrating an exemplary correlator in accordance with the teachings of the present invention;

FIG. 3 is a flowchart of a method of verifying a display in accordance with the teachings of the present invention;

FIG. 4 is a block diagram of another embodiment of a display verification system in accordance with the teachings of the present invention;

FIG. 5 is a flowchart of a method of verifying a display in accordance with a second embodiment of the present invention;

FIG. 6a-6b illustrate exemplary templates in accordance with the teachings of the present invention; and

FIG. 7 illustrates a screen having a capture area and symbology in accordance with the teachings of the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

An image monitoring method and system in one embodiment of the present invention provides for the monitoring of display inputs and data generated using the display inputs to ensure that critical data will be properly displayed. In the present invention, the image monitoring system uses at least a portion of a rendered pixilated image known as a comparison location and known pixel-based templates of the symbology that can be displayed in the monitoring process to calculate a correlation value. When the correlation value exceeds a predetermined threshold, a match is verified. The templates are pixel-based model shapes based on the desired symbology to be displayed. The symbology can be any alphanumeric character or shape that can be displayed on a display.

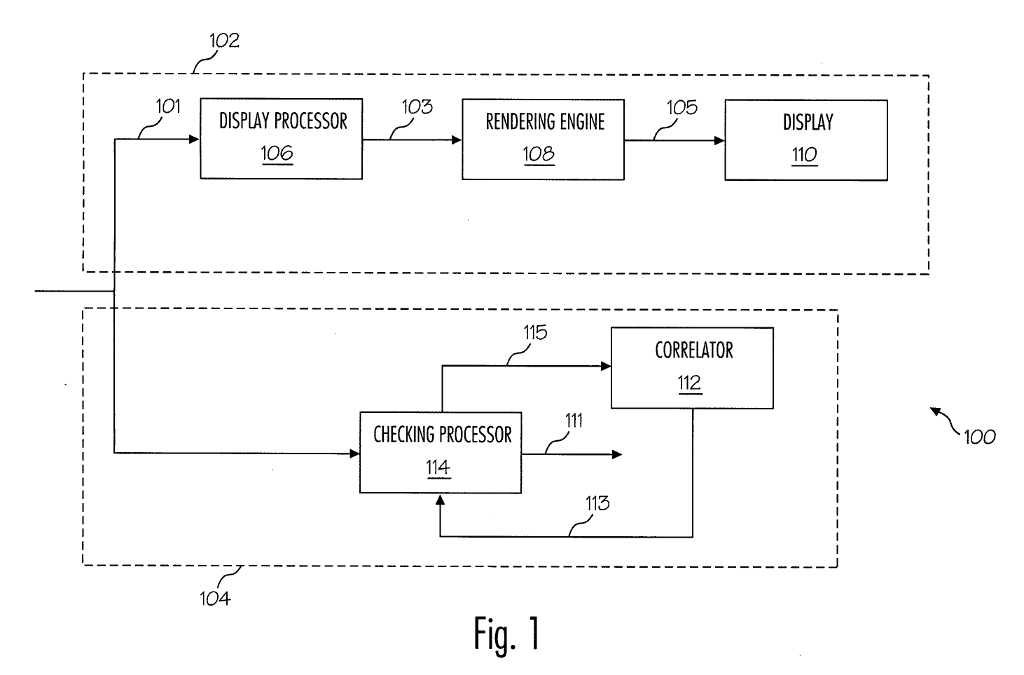

FIG. 1 illustrates an exemplary monitored display system 100 in accordance with the teachings of the present invention. Monitored display system 100 includes a display portion 102 and a monitoring portion 104. Display portion 102 receives data generated by other systems for display, generates image data 105 in the form of a plurality of pixel values and displays the image. Display portion 102 includes a display processor 106 coupled to a rendering engine 108, which couples to display 110.

Display processor 106 receives input parameters 101 from other systems and generates display (also known as rendering) commands 103 from the input parameters 101. For example, the inertial reference system and the altimeter can send data to the display processor 106 for display on the display 110. Display processor 106 can be any processor capable of generating display commands such as the general purpose processors manufactured by Intel or Motorola.

Rendering engine 108 receives the display commands 103 from display processor 106 and generates image data 105, comprising pixel values (usually red, green and blue intensities), from the display commands 103. Typical rendering engines are manufactured by NVIDIA or ATI, although any processor or integrated circuit operable to act as a rendering engine 108 can be used. Display processor 106 and rendering engine 108 can be provided on a single integrated circuit or they can be provided on separate integrated circuits. Likewise, in accordance with the teachings of the present invention, the exact functions assigned to the display processor 106 and the rendering engine 108 can be altered.

Display 110 receives the image data 105 produced by the rendering engine 108 and uses the data to produce an image. Display 110 can be any pixel based display, such as CRT raster displays and LCD displays. Exemplary displays are manufactured by Honeywell, Inc.

Monitoring portion 104 samples image data 105 from the display portion 102 and verifies the accuracy of display portion 102. In one embodiment, monitoring portion 104 includes a correlator 112 and a checking processor 114.

Correlator 112 captures all or part of the image data 105 produced by the rendering engine 108 that can also sent to the display 110. The correlator 112 compares the shape of the symbology within comparison locations in the captured image data 105 to one or more templates provided by the checking processor 114 as location/template data 115 by calculating correlation values based on the templates and the symbology located within the comparison locations of the captured image data 105. The correlation value can be checked against a threshold and a match between the symbology in the comparison location and the template can be determined if the correlation value exceeds the threshold. If, after all comparisons are completed, no correlation value exceeds a threshold, a signal 111 indicative of a warning can be generated. The result data 113 generated by correlator 112 can be provided to the checking processor 114.

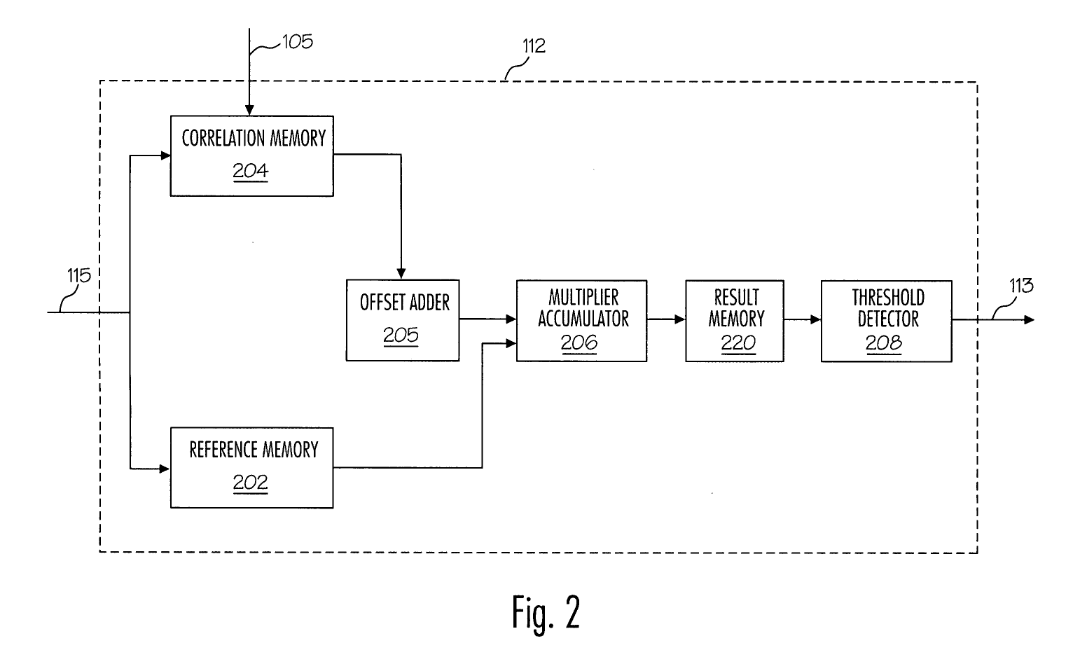

Correlator 112, in one embodiment of the present invention, and with reference to FIG. 2, comprises a reference memory 202 and correlation memory 204, both of which receives input data location/template data 115. In a typical embodiment, the template data comprising one or more templates can be stored in reference memory 202 and the location information, comprising at least the comparison location, can be stored, along with the image data 105, in the correlation memory 204. Correlation memory 204 and reference memory 202 can be any conventional memory, such as RAM, flash memory and the like. While reference memory 202 and correlation memory 204 are illustrated as separate memories, the memories can be combined.

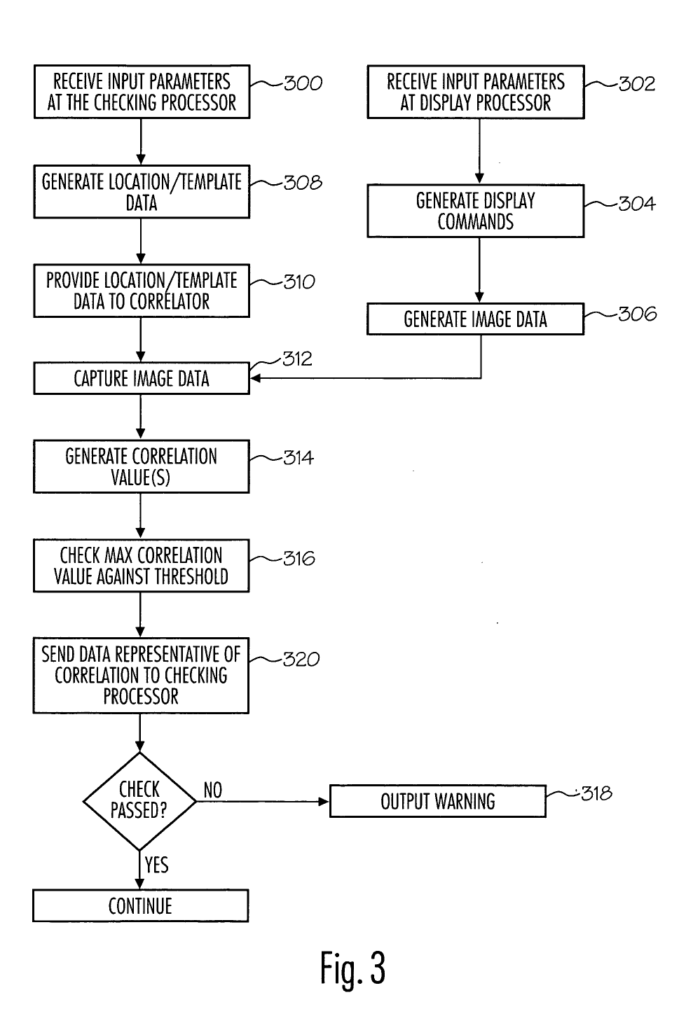

Correlation memory 204 can be coupled to an optional offset adder 205 which provides adjustments to the comparison locations stored in correlation memory 204. The offset is discussed in greater detail with reference to FIG. 3. A multiplier accumulator 206 can be coupled to the reference memory 202 and the correlation memory 204 and determines the correlation value from the comparison locations and the template data. The correlation value and any associated information can be stored in results memory 220. A threshold detector 208 checks the correlation value or values against a threshold value, with a match occurring, in one embodiment, when the threshold value is exceeded by the correlation value. The design of offset adders, multiplier accumulators and threshold detectors are well-known in the art.

The components of correlator 112 as shown in FIG. 2 are for exemplary purposes only. Various substitutions for components as well as combinations of components can be made without departing from the teachings of the present invention. In addition, portions of the correlator 112 function may be performed by the checking processor 114 without departing from the scope and teachings of the present invention.

Checking processor 114 receives the original input parameters 101 that produced the image data 105. Checking processor 114 uses the input parameters 101 to independently generate one or more templates to be used by the correlator 112 and the location data specifying one or more comparison locations within the image data 105. The templates and comparison locations can be used to verify the symbology generated by the display processor 106, using algorithms that may be the same or similar to the algorithms display processor 106 uses. In one embodiment, the template data may be derived by the checking processor 114 based on knowledge of the possible shapes that may be displayed in the display system. Alternatively, the template data may be derived before use of the display processor 106 and stored in checking processor 114 or in correlator 112 without departing from the scope and teachings of the present invention. The checking processor 114 provides the template data and the location data to the correlator as location/template data 115. Checking processor 114 may also verify the correlator 112 used the correct template and comparison location to calculate the correlation value by receiving data representative of the correlation value calculation, such as, in one embodiment, data specifying the template and comparison location used to calculate the correlation value. In the event of any failure, the verification process fails and a signal 111 can be outputted to an external system, which may issue a warning that there is a potential display system malfunction or may disable display 110.

In one exemplary embodiment of the use of the present invention, and with reference to the flowchart of FIG. 3, input parameters 101 that include information to be displayed, such as data from the attitude control system, the altimeter or any other system or systems external to the display system 100, are received at the display processor 106 (step 302). The display processor 106 generates the display commands 103 from the input parameters 101 (step 304). The rendering engine 108 produces the image data 105 from the display commands 103 (step 306). While shown as two different components, in one embodiment, the display processor 106 and rendering engine 108 can be provided as a single integrated circuit.

Input parameters 101 are also received by the checking processor 114 (step 300). The checking processor 114 uses similar or the same algorithms as those used by the display processor 106 to determine from the input parameters 101 what symbology should appear on the display 110 and where the symbology should be located. Checking processor 114 further selects or generates the correct template or templates to use to verify the symbology and the comparison location or locations within the image data where the template will be applied (step 308). The templates and location data are sent to the correlator 112 as location/template data 115 (step 310). As discussed previously, in a typical embodiment, the template data can be stored in the reference memory 202 of the correlator 112 and the location data can be stored in the correlation memory 204. In an alternative embodiment, the templates can be stored at the correlator 112 before any verification process is initiated. In this embodiment, all of the possible symbology that would need to be verified can be represented by an individual template. Also, in this embodiment, the pre-stored templates would be omitted from the location/template data 115 provided by step 310.

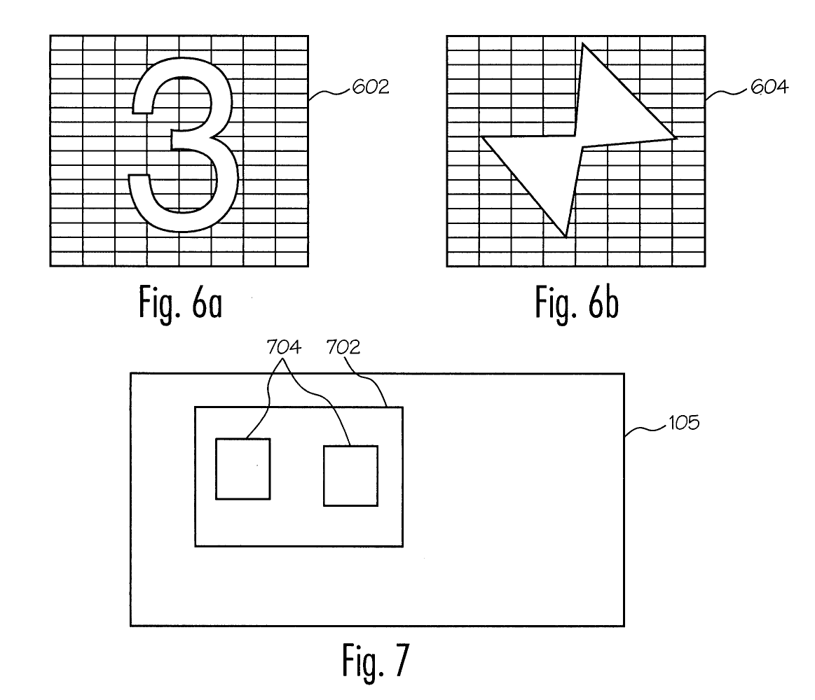

An example of template and location data is illustrated in FIG. 6-7. FIG. 6a illustrates a numerical template 602 for the number three. This template can be used to verify that a number at a specific location is the number three. Various templates can exist for each number 0-9 as well as other alphanumeric characters. Also, templates can exist for each possible shape that can be displayed on the display. For example, line template 604 of FIG. 6b can be used to verify if lines (having a limited range of angle) are present within the search area.

It should be appreciated that the strategies used to verify the symbology displayed depend on the nature of the symbology to be checked and the ability of the viewer to detect errors. For example, if the data is numerical characters, the strategy may be to compare each character with the 10 digits (0-9) of the same size, because the user will realize that there is an error if a letter or a smaller digit appears when a digit of a certain size is expected. For a line, such as a horizon line or a flight director command bar, the strategy might be to use a template with a line somewhat slightly wider than the expected line (to accommodate slight variations in angle as in template 604) and match it to several positions near each end of the line. The user would be expected to recognize the problem if the line were actually broken into fragments, so the entire line would not need to be matched to a template.

In one embodiment, the templates stored at reference memory 202 of the correlator 112 can be sixteen 32 by 64 pixels by 8 bit templates. The actual number and size of the templates can be varied without departing from the teachings of the present invention. Additionally, each template may include an offset value, such as an 8 bit offset value, associated with the template and saved in the reference memory 202. The offset can be used to shift the intensity range of the image data to match the intensity range of the template. Typically image data will range from zero (0) for a maximum for black to full intensity, where as the template will have a range from negative maximum for black to positive maximum for full intensity. By applying one half of full scale as an offset, the black areas will become the negative maximum and will contribute strongly to the correlation, whereas if there was no offset, areas that were black would not contribute to the correlation, positively or negatively. The undesired result would be that blocks of pixels of full white intensity would correlate fully with all templates

As discussed previously, the correlator 112 receives the location/template data 115 from the checking processor 114. Part of the location/template data 115 concerns the templates and can be stored in a reference memory 202. The other part of the location/template data 115 includes location information such as one or more comparison locations and can be stored in correlation memory 204. Referring to FIG. 7, the location information can include a capture area 702 of the image data 105 which specifies what portion of the image data 105 will be captured by the correlator 112. Also, the location information includes at least one comparison location 704 within the capture area 702 that will be used for verification purposes. In one embodiment, the capture area 702 is a 128 pixel wide by 64 pixel high portion of the image data 105. In one embodiment, the capture area can be derived from the comparison location 704. The location information, will typically be stored in correlation memory 204, could also be stored in reference memory 202 or in a control memory (not shown). The correlator 112 then captures the image data 105 generated by the rendering engine 108 and corresponding to the capture area 702 and stores the data in the correlation memory 204 (step 312).

Next, the multiplier accumulator 206 can be used to calculate one or more correlation values by summing the product of the template pixel values for a selected template in memory 202 and the corresponding pixel values of a comparison location 704, which may be stored in correlation memory 204 (step 314). This can be represented by the following equation:

$$Correlation = {\sum }_{over full template} [ ( Template ) * ( ComparisonLocation - Offset ) ]$$

The Offset is the offset of the template added by offset adder 205. The use of the offset is optional. A correlation will be calculated for each template and comparison location specified in the location/template data 115.

To compute the correlation value, in one embodiment each of the pixels captured as part of the image data 105 can be assigned intensity values based on the content of the pixel. For example, for color displays the three color component for each pixel can be added together to form an intensity value for each pixel to be used in the correlation calculation. Alternatively, for each pixel the largest of the color components of the pixels can be chosen. In either case, the values for the pixels in both the template and the capture area can be scaled or quantized to make the calculation of the correlation faster and to decrease the storage requirement for the templates. For example, this can be done by quantizing the template value to 1, 0 or −1. Any other ways of assigning values to pixels in an image fall within the scope and teachings of the present invention. Once the pixels of the template and the pixels of the comparison locations are assigned values, each individual pixel value from the template and comparison location can be multiplied together and all of the products can be summed.

After the correlation value is calculated, the correlation value can be checked using the threshold detector 208 to determine if the correlation value exceeds a certain threshold value (step 316). If the correlation value exceeds the threshold value than there is a match between the template used to compute the correlation and the symbology in the comparison location. The threshold value can be chosen such that a match occurs at a high enough threshold to eliminate false matches but allow for smaller variations caused by slight variations in the image, such as might be caused by slight changes in location of the symbol. In one embodiment, the threshold value can be a fixed, predetermined value.

In another embodiment, the threshold is based on an average of a set of correlation values determined by calculating a correlation value for a given template against each of a set of overlapping or adjacent comparison locations. The threshold value can be set as a percentage of the average of the set of correlation values.

For some images it may be advantageous to group the templates or comparison locations and take the highest correlation value (that also exceeds the threshold) as the match. This can be used in two distinct ways; with several templates (for example several numerical characters) to determine the best match, or for one template, determining a correlation value at each location in a series of closely spaced locations (for example a 3 by 3 grid displaced by one pixel in each direction) in order to determine the exact location of a symbol.

In one embodiment, steps 310 and 312 are calculated for each template stored in the reference memory 202 and the results can be stored in result memory 220. Each of these correlation values are checked against the threshold in threshold detector 208 and the best (highest correlation value) matching template is found. In this embodiment, the templates to use do not have to be chosen by the checking processor 114.

Once the correct template and location threshold are found or verified, the correlator 112 can send data representation of the correlation to checking processor 114. In one embodiment the data can be an indication of whether the correlation value exceeded a threshold. In another embodiment, the data representation of the correlation can be the template identification (or the template) and the comparison location of at least one of the matches can be sent as result data 113 to the checking processor 114. The checking processor 114 can determine if the template represented by the result data 113 and located at the location specified in result data 113 are the same as those generated by the original input parameters 101 (step 320). If there is no match, the checking processor 114 will output a signal 111 to cause a warning to be displayed or to disable the display 110 (step 318).

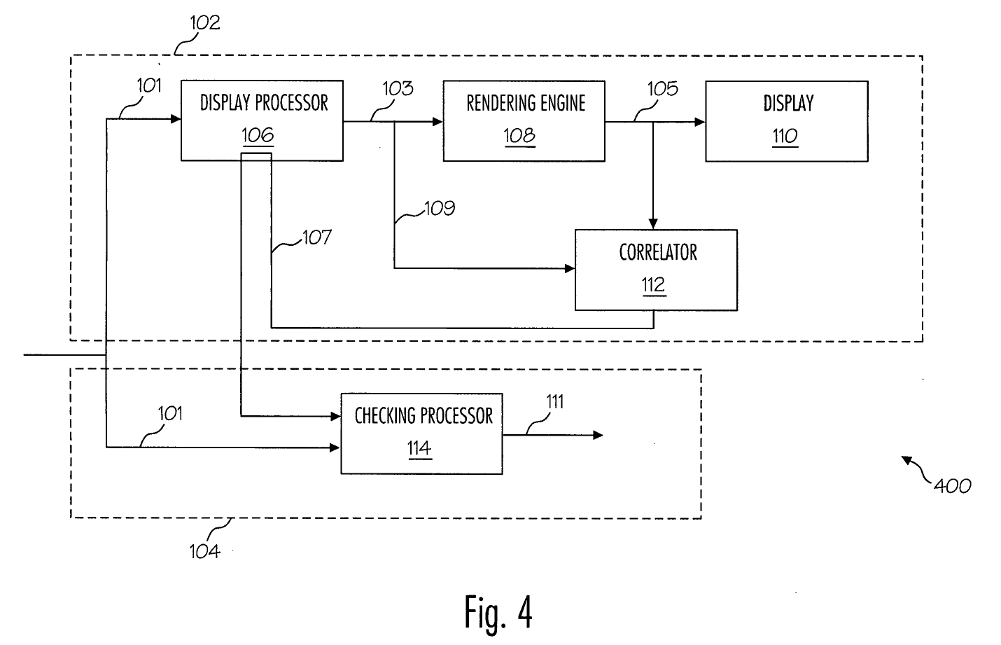

Another embodiment of an image monitoring system 400 in accordance with the teachings of the present invention is illustrated in FIG. 4. The embodiment of FIG. 1 provides independence between the image generation and the image checking easily because the monitoring portion 104 is physically separate from the display portion 102, sharing only the input parameters 101 and the image data 105. However, when the monitoring portion 104 and the display portion 102 are physically separated like the embodiment of FIG. 1, a high speed connection is required to provide the image data 105 to the monitoring portion 104. Therefore, to decrease the cost of the high speed connection, certain display system designs locate the correlator 112 in close proximity to the rendering engine 108 and the display processor 106. In display systems where the monitoring portion 104 is not physically separated from the display portion 102, additional checks are made to monitor the display system.

An exemplary monitoring system where the monitoring portion 104 is not physically separated from the display portion 102 is illustrated in FIG. 4. The image monitoring system 400 includes the same basic components as those in FIG. 1. However, additional functionality is provided in some components to compensate for the loss of structural independence in image monitoring system 400.

In this embodiment, correlator 112 is physically part of the display portion 102 and receives its location/template data 109 from display processor 106. The location/template data 109 can be calculated from the input parameters 101 in a similar manner to the way the checking processor 114 calculated the location/template data 115 in the previous embodiment. However in this embodiment the location/template data 109 is not independent because an error in display processor 106 could corrupt both the image data 105 and the location/template data 109 in a similar manner.

In one embodiment of the present invention, the correlator 112 operates in a similar manner to the correlator 112 in the previous embodiment. That is, it uses the location/template data 109 from the display processor 106 and the image data 105 to calculate a correlation value. In this embodiment the correlator 112 includes the location/template data 109 it used to calculate the correlation value within a match data packet 107 that is eventually sent to the checking processor 114.

The template data in the match data packet 107 may include the actual template used or the identification of a template already stored at correlator 112. Alternatively correlator 112 can calculate a cyclic redundancy check (CRC) value for each of the templates used and include the CRC in the match data in lieu of the template itself. The location data, typically in the form of a comparison location, from location/template data 109, the template used or the CRC value for that template and, optionally, the correlation value are grouped together. A packet CRC value can then calculated based on all of the data. The location data, the template CRC, the correlation value optionally and the overall CRC then form a match data packet 107.

The match data packet 107 can be transmitted to the checking processor 114, through the display processor 106, using whatever interprocessor communications is provided by the system 400. While this is not an independent operation, as a fault in the display processor 106 might cause a display error and compensating error in the match data packet 107, the corruption of the data can be easily detectable by the packet CRC on that data.

The checking processor 114 in this embodiment performs additional checks over those of the embodiment of FIG. 1 to ensure that a fault in the display processor 106 has not corrupted the location/template data 109 that controls the operation of the correlator 112 or the match data package 107 transferred to the checking processor 114. The checking processor 114 first calculates the location/template data 109 from input parameters 101 similarly to the previous embodiment to independently determine the comparison location and the previous template or the CRC of the template associated with the comparison location. The results are checked against the comparison location and the CRC of the template in the match data packet 107 or against the actual template in match data packet 107. Additionally, if the correlation value is provided, checking processor 114 can independently check if the correlation value exceeded the threshold. Thus, any fault in the display processor 106 that causes an error in the location/template data 115 will be detected.

The checking processor 114 also checks the CRC on the match data packet 107 that it receives, in order to detect any error in the data that may have been introduced by a fault in the data transmission, including by display processor 106.

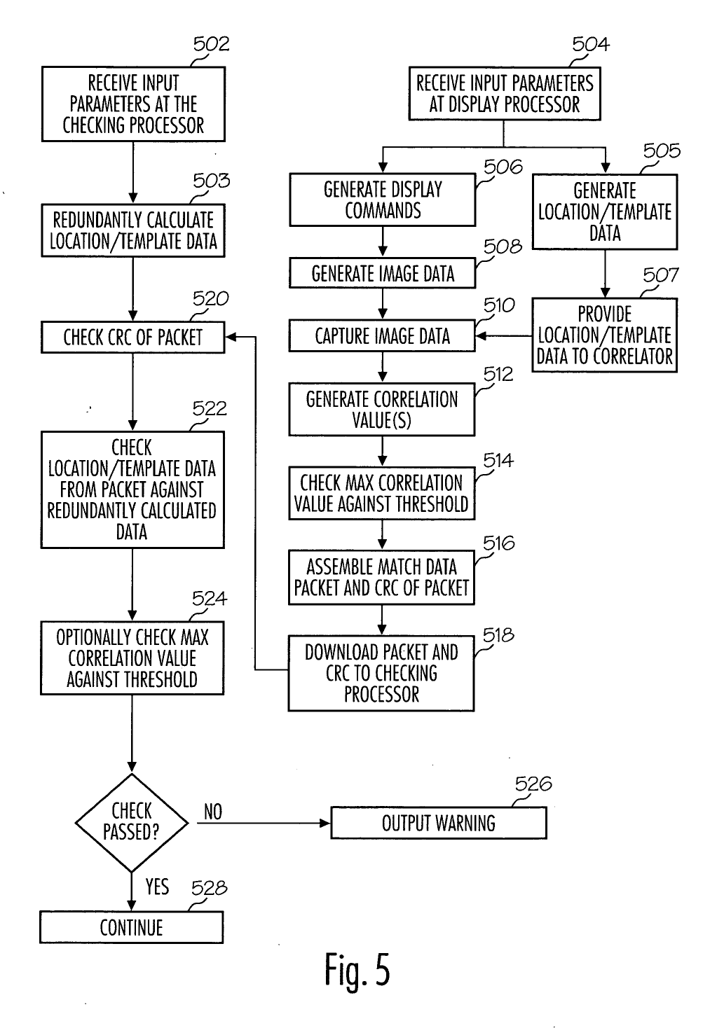

An exemplary embodiment of the system of FIG. 4 in operation can be described with reference to the flowchart of FIG. 5. In the flowchart of FIG. 5, there is a flow path for activities occurring in the display portion 102 and a flow path for activities occurring in the monitoring portion 104. As before, the display processor 106 and rendering engine 108 work to produce an array of pixels that represents the image to be produced. Initially, display processor 106 receives input parameters 101 generated by other systems or test data (step 504). The display processor 106 uses the input parameters 101 to produce the display commands 103 (step 506). The rendering engine 108 uses the display commands 103 to produce the image data 105 (step 508). As discussed previously, in one embodiment, the display processor 106 and rendering engine 108 can be provided as a single integrated circuit. Display processor 106 also generates the location/template data b 109 (step 505) and sends it to the correlator 112 (step 507).

The image data 105 is captured by the correlator 112 (step 510). The correlator 112 uses the location and template data 109 from the display processor 106 to determine if the given shape is in the given area. Again, this can be done by calculating at least one correlation value using one or more comparison locations and one or more templates from the location/template data 109 (step 512) and comparing the calculated correlation value to a threshold value (step 514). If the correlation value exceeds the threshold value, a match occurs. In embodiments where more than one correlation values are calculated, the correlation values can be stored in the result memory 220 of the correlator 112. After all of the correlation values have been calculated, the largest value can be chosen for comparison to the threshold.

Once the correct template and comparison locations are found, the correlator 112 will assemble a match data packet 107 containing, in one embodiment, a CRC value calculated from the template, the calculated correlation value (the inclusion of the correlation value can be optional), the position data originally sent to the correlator 112, and a CRC calculated based on the data in the match data packet 107 (step 516). In the embodiment of FIG. 4 and FIG. 5, the data representative of correlation includes the mach data packet 107 and the CRC of the packet. In one embodiment, the match data packet 107 contains only the information originally sent from the display processor; i.e., the CRC value calculated from the template (or the template or identification of the template, such as a template identification number) and the comparison location. The packet is then sent to the display processor 106 which then transmits the match data packet 107 to the checking processor 114 by whatever inter-processor communication means are available (step 518).

The checking processor 114 receives the same input parameters 101 that the display processor 106 received (step 502). The checking processor 114 independently determines the appropriate template and comparison locations from the input parameters 101 (step 503). After the checking processor 114 receives the match data packet 107, the checking processor 114 calculates the CRC of the data in the match data packet 107 and verifies the calculated CRC matches the one calculated for the match packet data 107 (step 520). This ensures that the display processor 106 did not corrupt the match data packet 107.

The checking processor 114 then uses the redundantly calculated location and template data from step 503 to verify the comparison location and template data used by correlator 112 and provided in the match data packet 107 is correct (step 522). This ensures that the display processor 106 did not have a fault that corrupted the location/template data 115 sent to the correlator 112. The checking process also verifies that the correlation value did exceed the chosen threshold if the correlation value is included in the match data packet 107 (step 524). If any of the verifications in steps 520, 522, or 524 fail, a warning or other response can be generated (step 526).

Since errors in all of the operations display processor 106 performs in support of the checking process are detectable by the checking processor 114, the independence of the checking from faults in the display generation can be established.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for verifying the accuracy of image data generated by a display processor from an initial set of input parameters, the method comprising:
capturing image data at a correlator;
receiving at least one comparison location including a first symbology within the image data;
receiving a template representing a second symbology;
calculating a correlation value using the comparison location and the template;
comparing the correlation value to a threshold value; and
determining a match between the first symbology appearing in the comparison location and the symbology represented by the template if the correlation value exceeds the threshold value.

2. The method of claim 1 wherein the step of calculating a correlation value further comprises summing the product of the pixel values of the comparison location multiplied by the pixel values of the template.

3. The method of claim 1 where the step of calculating a correlation value further comprises:
calculating two or more correlation values by comparing the comparison location with each of two or more individual templates; and
selecting the template associated with the largest correlation value calculated.

4. The method of claim 1 where the step of calculating a correlation value further comprises:
calculating two or more correlation values by comparing the comparison location with the template and with the template translated in at least one of four directions; and
selecting the template associated with the largest correlation value calculated.

5. The method of claim 1 further comprising the step of setting the threshold as a fixed percentage of the average of a set of correlation values calculated using a template and a set of comparison locations.

6. The method of claim 1 wherein the step of receiving at least one comparison location further comprises receiving at least one comparison location selected by a checking processor from the image data.

7. The method of claim 1 wherein the steps of receiving at least one comparison location and receiving a template further comprises receiving the comparison location and the template data from the display processor.

8. The method of claim 7 further comprising the steps of:
calculating a cyclic redundancy check value for the template used to calculate the correlation value;
forming a data packet comprising the cyclic redundancy check value for the template and the comparison location;
calculating a packet cyclic redundancy check value based on the data packet contents; and
sending the packet and packet cyclic redundancy check value to a checking processor for verification.

9. The method of claim 7 further comprising the steps of:
forming a data packet comprising the template and the comparison location used to calculate the correlation value;
calculating a packet cyclic redundancy check value based on the data packet content; and
sending the packet and packet cyclic redundancy check value to a checking processor for verification.

10. The method of claim 8 further comprising:
determining at the checking processor the cyclic redundancy check value for the template and the comparison location using the input data;
comparing the cyclic redundancy check value for the template and the comparison location determined at the checking processor with the cyclic redundancy check value for the template and the comparison location in the data packet; and
outputting a warning if the cyclic redundancy check value for the template and the comparison location determined at the checking processor do not match the cyclic redundancy check value for the template and the comparison location in the data packet.

11. The method of claim 9 further comprising:
determining at the checking processor the template and the comparison location using the input data;
comparing the template and the comparison location determined at the checking processor with the template and the comparison location in the data packet; and
outputting a warning if the cyclic redundancy check value for the template and the comparison location determined at the checking processor do not match the cyclic redundancy check value for the template and the comparison location in the data packet.

12. The method of claim 8 further comprising:
independently calculating the packet CRC value at the checking processor; and
outputting a warning that the display processor corrupted the data if the packet CRC value calculated by the checking processor does not match the CRC value calculated by the correlator.

13. A system for verifying the accuracy of an image generated by a display system comprising:
a correlator circuit operable to capture image data produced by a rendering engine from a set of input data and determine a correlation value calculated using a comparison location within the image data and a template; the correlator further operable to compare the correlation value against a threshold value to determine a match between the comparison location within the image data and the template; and
a checking processor coupled to the correlator circuit and operable to receives data representative of the correlation value calculated from the correlator and further operable to initiate a warning in the event of any error in the data representative of the correlation value calculated.

14. The system of claim 13 wherein the correlation value is determined, at least in part, by the sum of the product of the pixel values of the comparison location multiplied by the pixel value of the template.

15. The system of claim 13 where the correlation value is determined, at least in part, by calculating two or more correlation values by summing the products of the pixel values of the comparison location with the pixel values of the template and the pixel values of the template translated in at least one of four directions; and selecting the largest correlation value calculated.

16. The system of claim 13 where the correlation value is determined, at least in part, by calculating two or more correlation values by summing the products of the pixel values of the comparison location with the pixel values of of two or more templates and selecting the largest correlation value calculated.

17. The system of claim 13 wherein the template and comparison location are determined by the checking processor from the image data independent of the display processor.

18. The system of claim 13 wherein the comparison location and template data are received at the correlator from a display processor.

19. The system of claim 18 wherein the correlator is further operable to:
generate a cyclic redundancy check value for the template used to calculate the correlation value from the display processor;
form a data packet comprising the comparison location and the CRC of the template;
calculate a packet cyclic redundancy check value based on the data packet contents; and
send the data packet and packet cyclic redundancy check value to a checking processor.

20. The system of claim 19 wherein the checking processor is further operable to:
independently determine the comparison location and the template using the input data;
compare the comparison location and the template determined at the checking processor with the comparison location and the template determined by the display processor; and
verify the accuracy of the generated image data if the comparison matches.

21. The system of claim 19 wherein the checking processor is further operable to:
independently calculate the packet CRC value; and
verify that the display processor did not corrupt data if the packet CRC value calculated by the checking processor matches the packet CRC value calculated by the correlator.

22. The system of claim 18 wherein the correlator is further operable to:
form a data packet comprising the comparison location and the template data;
calculate a packet cyclic redundancy check value based on the data packet contents; and
send the data packet and packet cyclic redundancy check value to a checking processor.

23. The system of claim 13 wherein the threshold is calculated as a percentage of a set of correlation values calculated using a template and a series of comparison locations.

24. A system for verifying the accuracy of an image generated by a display system comprising:
a means for capturing image data produced from a set of input data:
a means for determining a correlation value calculated using a comparison location within the image data and a template:
means for comparing the correlation value against a threshold value to determine a match between the comparison location within the image data and the template; and
a means for receiving data representative of the correlation value calculation and for initiating a warning in the event of any error in the data representative of the correlation.

25. The system of claim 24 wherein the a means for determining a correlation value determines the correlation value by the sum of the product of the pixel values of the comparison location multiplied by the pixel value of the template.

26. The system of claim 24 further comprising a means for generating the comparison location and template data.

27. The system of claim 24 further comprising a means for generating a result data packet comprising the data used to calculate the correlation value and a CRC calculated based on the contents of the result data packet.

28. The system of claim 27 further comprising:
a means for comparing the contents of the result data packet with an independently determined set of data used to calculate the correlation value; and
a means for producing as warning if the contents of the result data packet do not match the independently determined set of data used to calculate the correlation value.

29. The system of claim 27 further comprising:
a means for comparing the CRC of the result data packet with an independently determined CRC; and
a means for producing as warning if the CRC of the result data packet do not match the independently determined CRC.

30. The system of claim 24 wherein the threshold is calculated as a percentage of a set of correlation values calculated using a template and a series of comparison locations.
